(19) United States
(12) Patent Application Publication
(10) Pub. No.: US 2024/0049273 A1
(43) Pub. Date: Feb. 8, 2024

(54) METHOD OF RADIO RESOURCE ALLOCATION FOR A TN-NTN NETWORK

(71) Applicants: MEDIATEK INC., Hsinchu (TW); National Taiwan University, Taipei (TW)

(72) Inventors: Hao-Wei LEE, Hsinchu (TW); I-Kang FU, Hsinchu (TW); Chun-Chia CHEN, Hsinchu (TW); Chen-I LIAO, Hsinchu (TW); Hung-Yu WEI, Taipei City (TW)

(73) Assignees: MEDIATEK INC., Hsinchu (TW); National Taiwan University, Taipei (TW)

(21) Appl. No.: 18/361,045

(22) Filed: Jul. 28, 2023

Related U.S. Application Data
(60) Provisional application No. 63/370,131, filed on Aug. 2, 2022.

(51) Int. Cl. H04W 72/542; H04B 7/185

(52) U.S. Cl. CPC H04W 72/542; H04B 7/18539

(57) ABSTRACT

This disclosure provides a method, an apparatus, and a non-transitory computer-readable medium for radio resource allocation for a terrestrial network (TN) cell. In the method, the TN cell is determined to be outside a coverage of a first non-terrestrial network (NTN) cell. In response to the TN cell being outside the coverage of the first NTN cell, a radio resource is allocated to the TN cell based on a radio resource of the first NTN cell.

### INCORPORATION BY REFERENCE

This present disclosure claims the benefit of U.S. Patent Application No. 63/370,131, filed on Aug. 2, 2022, which is incorporated herein by reference in its entirety.

### TECHNICAL FIELD

The present disclosure relates to mobile network, and specifically to a procedure for radio resource allocation of a terrestrial and non-terrestrial (TN-NTN) system (or network).

### BACKGROUND

A mobile network can include a terrestrial network (TN) and/or a non-terrestrial network (NTN). Spectrum of the TN/NTN can be based on geographic locations. For example, in a populated area, a TN spectrum is acutely demanded while an NTN spectrum is poorly utilized; and in a remote area, there may not be a TN coverage, so the TN spectrum may not be used, while the NTN spectrum can be acutely demanded.

### SUMMARY

Aspects of the disclosure provide a method of radio resource allocation for a terrestrial network (TN) cell. The method includes determining that the TN cell is outside a coverage of a first non-terrestrial network (NTN) cell. In response to the TN cell being outside the coverage of the first NTN cell, the method further includes allocating a radio resource to the TN cell based on a radio resource of the first NTN cell.

In an embodiment, a frequency range of the radio resource allocated to the TN cell overlaps with a frequency range of the radio resource of the first NTN cell.

In an embodiment, a time duration of the radio resource allocated to the TN cell overlaps with a time duration of the radio resource of the first NTN cell.

In an embodiment, a polarization of the radio resource allocated to the TN cell is the same as a polarization of the radio resource of the first NTN cell.

In an embodiment, the method includes determining that the TN cell is in a coverage of a second NTN cell based on at least one of a distance comparison, an angle comparison, or a signal quality comparison between the TN cell and the second NTN cell, and determining that the TN cell is outside the coverage of the first NTN cell based on a coverage comparison between the first and second NTN cells.

In an embodiment, the distance comparison includes comparing a distance threshold with a distance difference between a reference point of the second NTN cell and a base station of the TN cell.

In an embodiment, the angle comparison includes comparing an angle threshold with an angle difference between a first direction of a satellite to a reference point of the second NTN cell and a second direction of the satellite to a base station of the TN cell. The satellite is associated with the second NTN cell.

In an embodiment, the signal quality comparison includes comparing a signal quality threshold with a signal quality of a reference signal sent from the second NTN cell to a base station of the TN cell.

In an embodiment, the coverage comparison includes comparing a distance threshold with a distance difference between the first NTN cell and the second NTN cell.

In an embodiment, the coverage comparison includes determining whether the coverage of the first NTN cell overlaps with the coverage of the second NTN cell.

In an embodiment, the first NTN cell and the second NTN cell are associated with a same satellite.

In an embodiment, the first NTN cell and the second NTN cell are associated with different satellites.

In an embodiment, the radio resources of the first NTN cell and the second NTN cell are different.

In an embodiment, in response to the radio resource of the first NTN cell being used for uplink transmission, the method includes determining that the radio resource allocated to the TN cell is used for uplink transmission. In response to the radio resource of the first NTN cell being used for downlink transmission, the method includes determining that the radio resource allocated to the TN cell is used for downlink transmission.

In an embodiment, in response to the radio resource of the first NTN cell being used for uplink transmission, the method includes determining that the radio resource allocated to the TN cell is used for downlink transmission. In response to the radio resource of the first NTN cell being used for downlink transmission, the method includes determining that the radio resource allocated to the TN cell is used for uplink transmission.

In an embodiment, the method includes transmitting reference signal configuration information to at least one of a satellite associated with the second NTN cell or a base station of the TN cell.

In an embodiment, the method includes performing data transmission between a base station (BS) of the TN cell and a user equipment (UE) based on the radio resource allocated to the TN cell.

In an embodiment, the method includes transmitting a cell configuration message from the BS to the UE to inform the UE to access the TN cell.

In an embodiment, the method includes transmitting a cell de-configuration message from the BS to the UE to inform the UE to leave the TN cell.

Aspects of the disclosure provide an apparatus for radio resource allocation for a TN cell. Processing circuitry of the apparatus determines that the TN cell is outside a coverage of a first NTN cell. In response to the TN cell being outside the coverage of the first NTN cell, the processing circuitry of the apparatus allocates a radio resource to the TN cell based on a radio resource of the first NTN cell.

Aspects of the disclosure provide a non-transitory computer-readable medium storing instructions which when executed by a processor cause the processor to perform any one or a combination of the above methods.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates an exemplary scenario depicting varying usage rates of the non-terrestrial network (NTN) spectrum and the terrestrial network (TN) spectrum in different geographic locations, according to embodiments of the disclosure;

FIGS. 2A-2D show exemplary uplink (UL) and downlink (DL) performances of the NTN when encountering interference from TN base stations (BSs) and TN user equipments (UEs), according to embodiments of the disclosure;

FIG. 3 illustrates an exemplary TN-NTN system (or network) according to embodiments of the disclosure;

FIG. 4 shows a flowchart illustrating an exemplary process of radio resource allocation of a TN-NTN system according to embodiments of the disclosure;

FIGS. 5A-5C show examples of determining an NTN beam coverage of an NTN beam according to embodiments of the disclosure;

FIGS. 6A-6C shows exemplary signal flow diagrams of a TN-NTN system according to embodiments of the disclosure; and

FIG. 7 shows an exemplary apparatus according to embodiments of the disclosure.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing an understanding of various concepts. However, these concepts may be practiced without these specific details.

Several aspects of telecommunication systems will now be presented with reference to various apparatuses and methods. These apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon a particular application and design constraints imposed on the overall system.

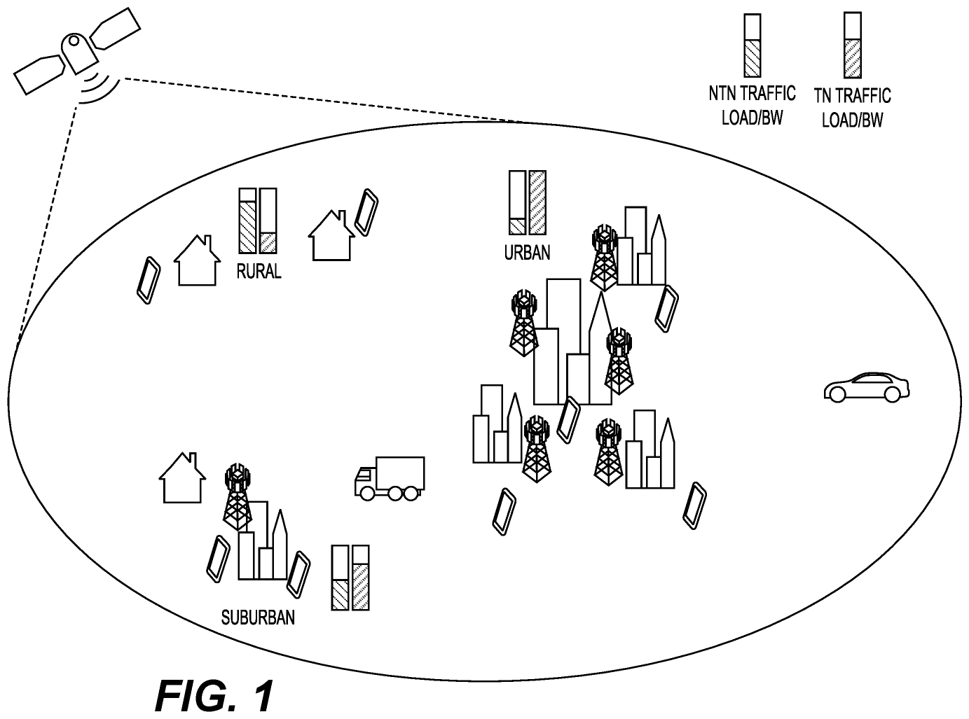

FIG. 1 illustrates an exemplary scenario depicting varying usage rates of the non-terrestrial network (NTN) spectrum and the terrestrial network (TN) spectrum in different geographic locations, according to embodiments of the disclosure. As shown in FIG. 1, in urban areas, there is a high demand for TN spectrum, while NTN spectrum utilization remains low. In suburban areas, NTN traffic load increases as TN traffic load decreases. In rural areas, there may be a lack of TN coverage, resulting in a shortage of NTN spectrum. Considering these disparities in spectrum utilization across different areas, it is desirable to allocate the spectrum resources in a coordinated manner so as to meet the specific demands of each geographic location and provide enhanced network services.

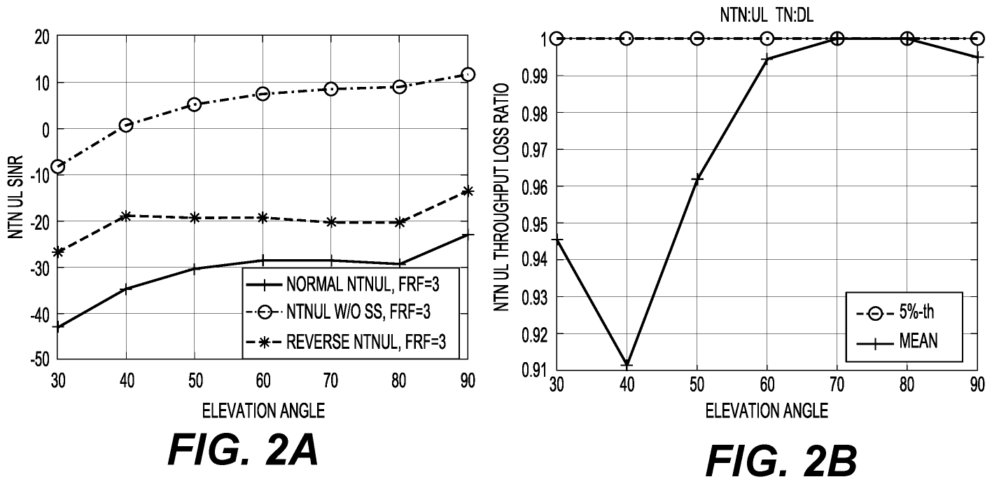

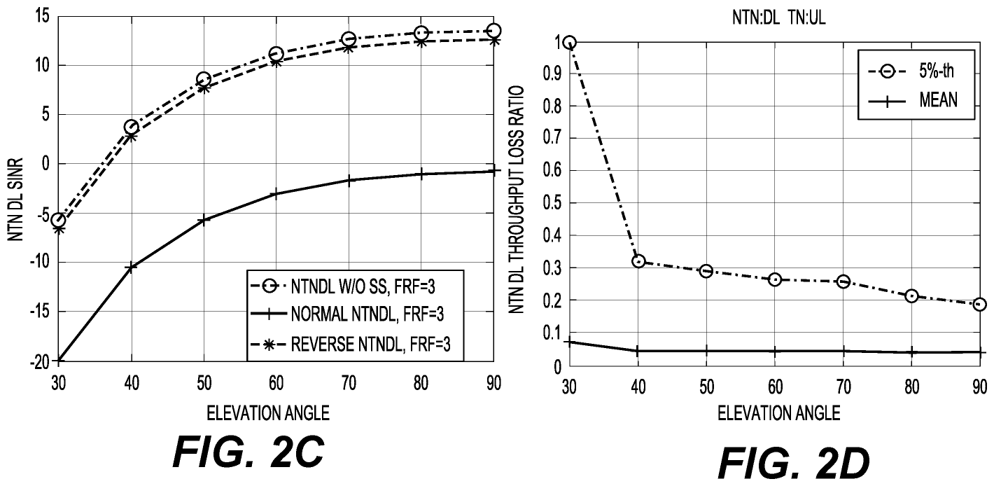

FIGS. 2A-2D show exemplary uplink (UL) and downlink (DL) performances of the NTN when encountering interference from TN base stations (BSs) and TN user equipments (UEs), according to embodiments of the disclosure.

As can be seen from FIGS. 2A and 2B regarding NTN UL performance, the average throughput loss ratio exceeds 90%, indicating significant degradation. NTN UL operations are heavily affected when the signal-to-interference-plus-noise ratio (SINR) falls below −10 dB. As can be seen from FIGS. 2C and 2D regarding NTN DL performance, the average throughput loss ratio is less than 10%. However, the 5%-tile worst NTN UE experiences a throughput loss ratio larger than 20%. The root causes for these issues can be attributed to severe aggregated TN BS interference and severe aggregated TN UE interference. To provide a reliable network experience, it is necessary to mitigate the impact of such interference on the performance of NTN communications.

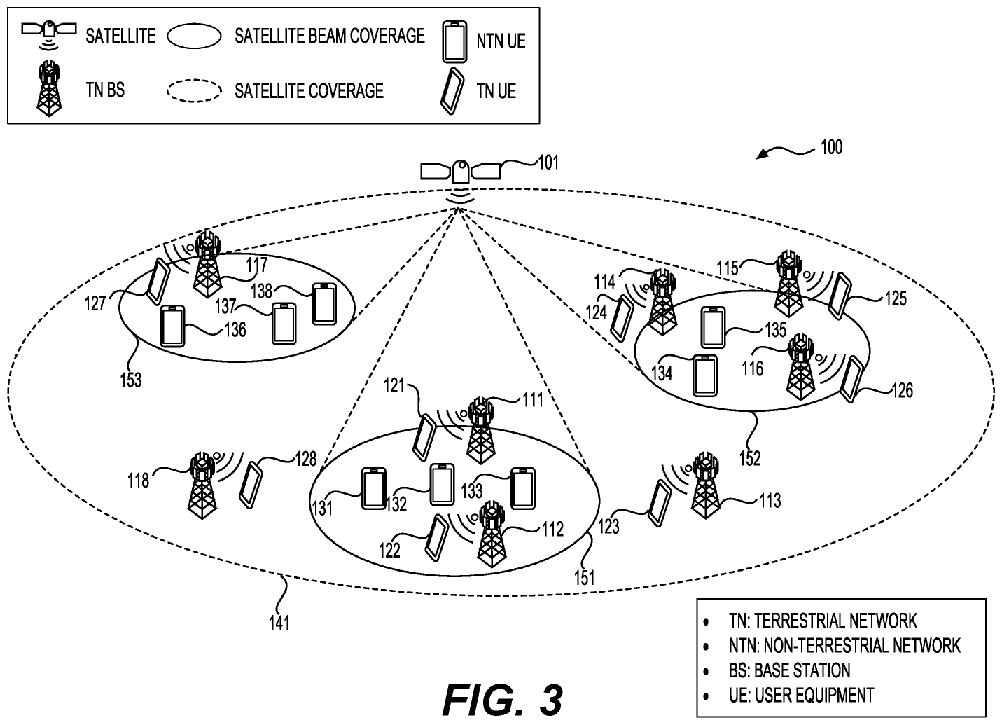

FIG. 3 illustrates an exemplary TN-NTN system (or network) 100 according to embodiments of the disclosure. The TN-NTN system 100 includes a satellite 101, a plurality of TN BSs 111-118, a plurality of TN UEs 121-128, and a plurality of NTN UEs 131-138. The plurality of TN BSs 111-118 can be located within a satellite coverage 141 (represented by a dashed ellipse) of the satellite 101, and serve the plurality of TN UEs 121-128 through the TN spectrum. The satellite 101 can have a plurality of NTN beams (or cells) each having a respective satellite beam coverage. One or more of the plurality of TN BSs 111-118 can be located within a satellite beam coverage of one of the plurality of NTN beams of the satellite 101. For example, the TN BSs 111-112 are located within a satellite beam coverage 151, the TN BSs 114-116 are located within a satellite beam coverage 152, and the TN BSs 117 is located within a satellite beam coverage 153. Moreover, the plurality of NTN UEs 131-138 can be within the satellite beam coverages 151-153 and access wireless communication services through the NTN spectrum.

It is noted that the TN-NTN system 100 can include more than one satellite in an embodiment. In addition, in this disclosure, a number of the TN BSs (or the TN UEs, the NTN UEs, the NTN beams of a satellite) is not limited.

Aspects of the disclosure provide embodiments of allocating a radio resource to a TN cell (e.g., the TN BS 111 or 112) based on a radio resource of a first NTN cell (e.g., the NTN cell 152 or 153). The TN cell (or a BS of the TN cell) can be outside a coverage of the first NTN cell. The TN cell can be within a coverage of a second NTN cell (e.g., the NTN cell 151). The radio resource allocated to the TN cell can fully or partially overlap with the radio resource of the first NTN cell. The radio resource can include, for example, a frequency range, a time duration, and/or a polarization.

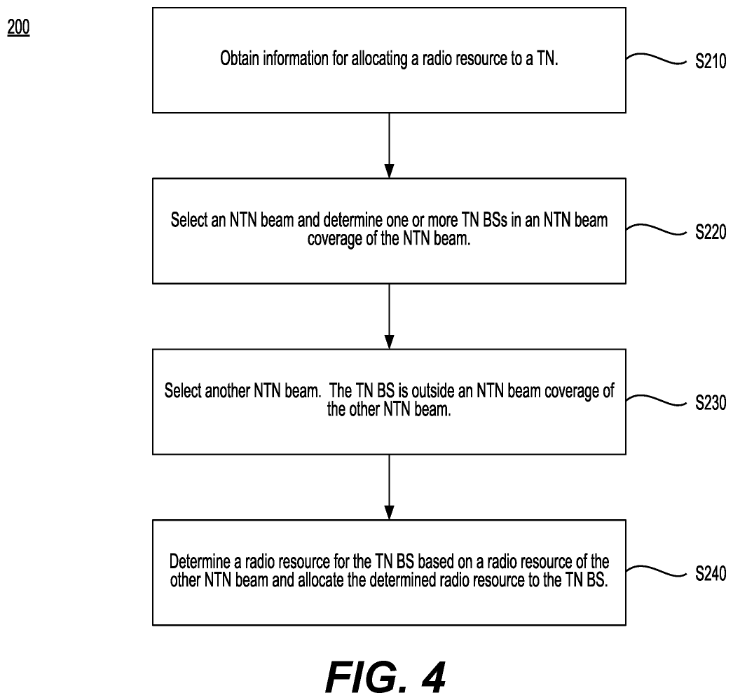

FIG. 4 shows a flowchart illustrating an exemplary process 200 of radio resource allocation of the TN-NTN system 100 according to embodiments of the disclosure. The process 200 can allocate a radio resource to a TN cell based on a radio resource of a first NTN cell of a satellite. The process 200 can be performed by processing circuitry (e.g., processing circuitry 710) of an apparatus (e.g., apparatus 700). The process 200 can be implemented as software instructions, which when executed by a computer device, can cause the computer device to perform the process 200.

The process 200 may start from step S210.

At step S210, the process 200 can obtain information for allocating a radio resource to a TN. The information for allocating the radio resource to the TN can be referred to as required information. The required information can include position information of a subset of (or all) BSs of a subset of (or all) TN cells under a coverage of the satellite, resource allocation information of a subset of (or all) NTN beams (or cells) of the satellite, and assistance information of each of the subset of (or all) NTN beams of the satellite for determining an NTN beam coverage of the respective NTN beam.

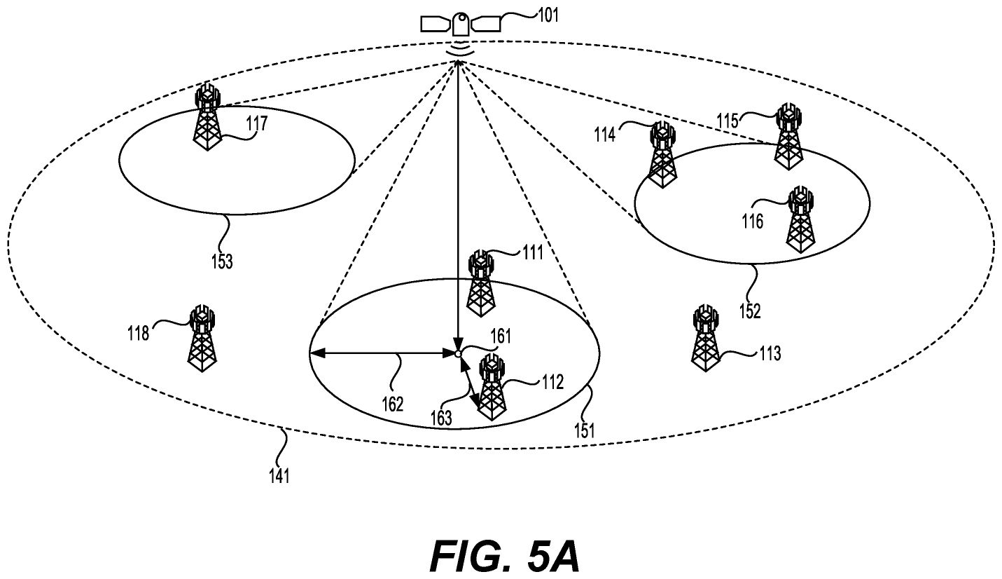

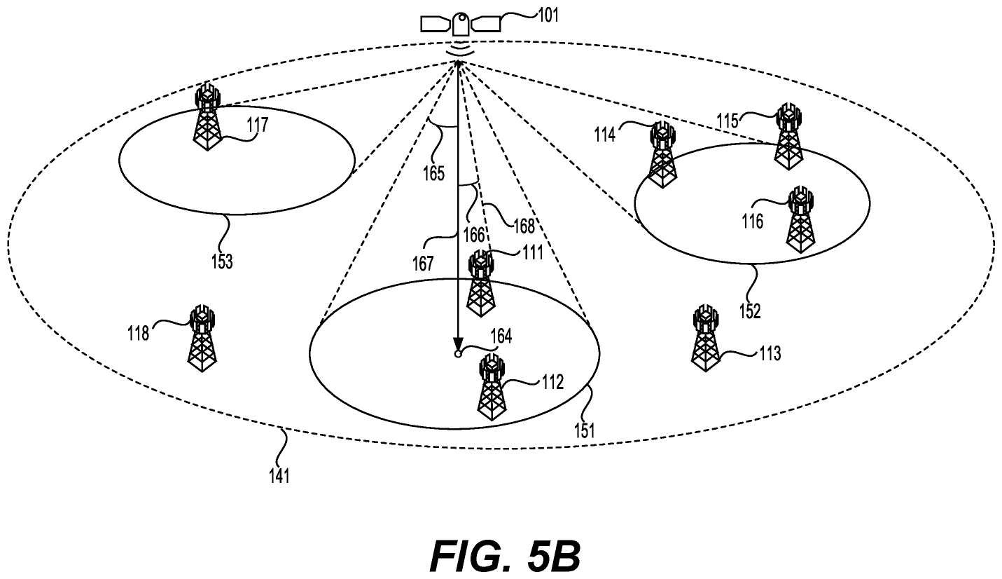

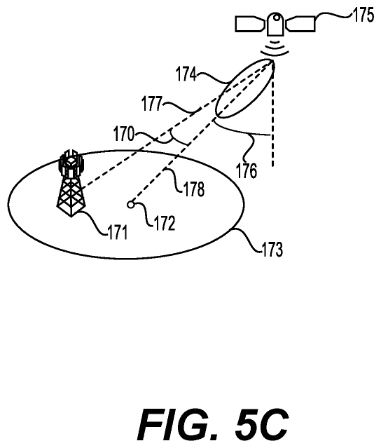

In an embodiment, the assistance information of an NTN beam for determining an NTN beam coverage of the NTN beam can include a reference point and a threshold for distance. For example, as shown in FIG. 5A, the satellite beam coverage 151 can be represented as a circular coverage area with a reference point 161 as a center of the circular coverage area and with a distance threshold 162 as a radius of the circular coverage area. In FIG. 5A, the TN BS 112 is in the satellite beam coverage 151 and a distance between the TN BS 112 and the reference point 161 is less than the distance threshold 162.

In an embodiment, the assistance information of an NTN beam for determining an NTN beam coverage of the NTN beam can include a reference point and a threshold for angle. The reference point can be a point on the earth which the beam direction is pointing to. For example, as shown in FIG. 5B, the satellite beam coverage 151 can be represented as an area with a reference point 164 and an angle threshold 165. In FIG. 5B, the TN BS 111 is in the satellite beam coverage 151 and an angle difference 166 between a beam direction 167 and a BS-satellite direction 168 is less than the angle threshold 165. The beam direction 167 is an NTN beam direction of an NTN beam corresponding to the beam coverage 151. The BS-satellite direction 168 is formed between the TN BS 111 and the satellite 101. The angle difference 166 is an NTN beam off-axis angle. That is, the angle difference 166 is a beam off-axis angle which is an angle difference between the direction 167 of the satellite 101 to the reference point 164 and the direction 168 of the satellite 101 to the TN BS 111. FIG. 5C shows an example of a beam off-axis angle 170. In FIG. 5C, the beam off-axis angle 170 is an angle difference between a direction 177 of a satellite 175 to a TN BS 171 and a direction 178 of the satellite 175 to a reference point 172 of a beam coverage 173. The beam coverage 173 is a beam coverage of a beam 174 of the satellite 175. The beam 174 is associated with a beam steering angle 176.

In an embodiment, the assistance information of an NTN beam for determining an NTN beam coverage of the NTN beam can include a signal quality threshold such as reference signal receive power (RSRP) threshold and/or reference signal received quality (RSRQ) threshold. The NTN beam coverage of the NTN beam can be determined by a set of positions where the received RSRP (or RSRQ) at a TN BS from the satellite corresponding to the NTN beam is greater than the RSRP (or RSRQ) threshold.

Then, the process 200 can proceed to step S220.

At step S220, the process 200 can determine (or select) an NTN beam (e.g., the second NTN beam) and determine one or more TN BSs in an NTN beam coverage of the NTN beam.

In an embodiment, when a distance between a TN BS and a reference point of an NTN beam coverage of an NTN beam is less than a distance threshold, the process 200 can determine that the TN BS is in the beam coverage of the NTN beam.

In an embodiment, when an angle difference between a beam direction of an NTN beam and a BS-satellite direction, which is formed between a TN BS and a satellite corresponding to the NTN beam, is less than an angle threshold, the process 200 can determine that the TN BS is in the beam coverage of the NTN beam. Given that the coordinates of the TN BS, the satellite, and the reference point of the NTN beam are [x_{BS}, y_{BS}, z_{BS}], [x_{SAT}, y_{SAT}, z_{SAT}], [x_{R}, y_{R}, z_{R}], respectively, when the TN BS is in the beam coverage of the NTN beam, the angle difference be can be represented as

$$θ = {COS}^{- 1} ( \frac{a \cdot b}{\vert a \vert \vert b \vert} ) < {θ}_{R} ,$$

where a=[(x_{BS}−x_{SAT}), (y_{BS}−y_{SAT}), (z_{BS}−z_{SAT})], b=[(x_{R}−x_{SAT}), (y_{R}−y_{SAT}), (z_{R}−z_{SAT})], and θ_{R} is the angle threshold.

In an embodiment, when the received RSRP (or RSRQ) of an NTN beam by a TN BS is larger than the RSRP (or RSRQ) threshold, the process 200 can determine that the TN BS is in the beam coverage of the NTN beam.

Then, the process 200 can proceed to step S230.

At step S230, the process 200 can select (or determines) another NTN beam (e.g., the first NTN beam). The TN BS is outside of an NTN beam coverage of the other NTN beam.

In an embodiment, a distance between the beam coverages of the first and second NTN beams is greater than a threshold.

In an embodiment, the beam coverages of the first and second NTN beams do not overlap with each other.

In an embodiment, the first and second NTN beams are connected to a same satellite.

In an embodiment, the first and second NTN beams are connected to different satellites.

Then, the process 200 can proceed to step S240.

At step S240, the process 200 can determine a radio resource for the TN BS based on a radio resource of the other NTN beam and allocate the determined radio resource to the TN BS.

In an embodiment, the process 200 can determine that a frequency range of the radio resource allocated to the TN BS can partially for fully overlap with the radio resource of the first NTN beam.

In an embodiment, the process 200 can determine that a time duration of the radio resource allocated to the TN BS can partially or fully overlap with the radio resource of the first NTN beam.

In an embodiment, the process 200 can determine that a polarization of the radio resource allocated to the TN BS can be same as a polarization of the radio resource of the first NTN beam.

In an embodiment, the process 200 can determine that the radio resource allocated to the TN BS is used for DL (or UL) TN transmission based on the radio resource of the first NTN beam being used for DL (or UL) NTN transmission.

In an embodiment, the process 200 determines that the radio resource allocated to the TN BS is used for DL (or UL) TN transmission based on the radio resource of the first NTN beam being used for UL (or DL) NTN transmission.

In an embodiment, the process 200 determines that the radio resource used in the first NTN beam is different from the radio resource used in the second NTN beam.

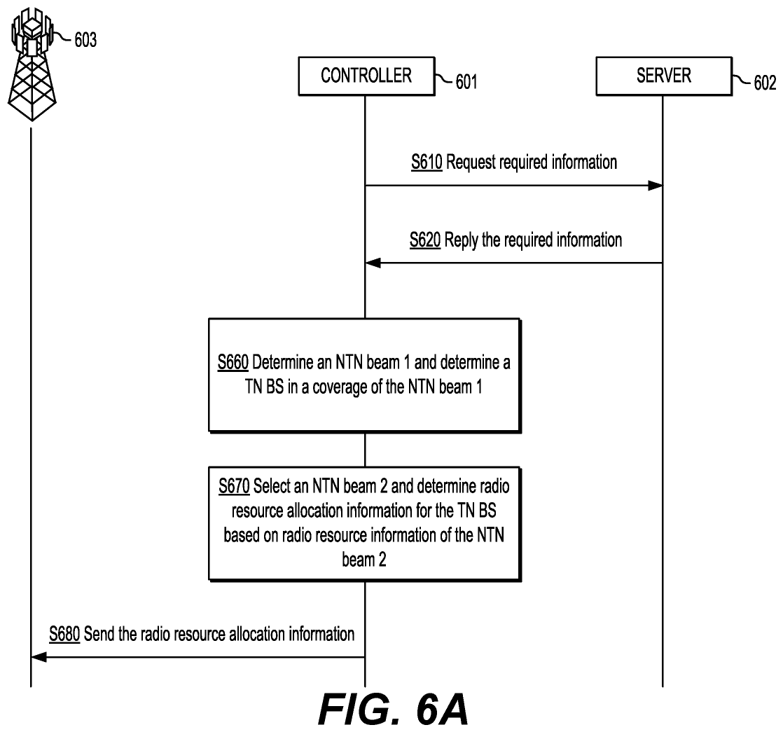

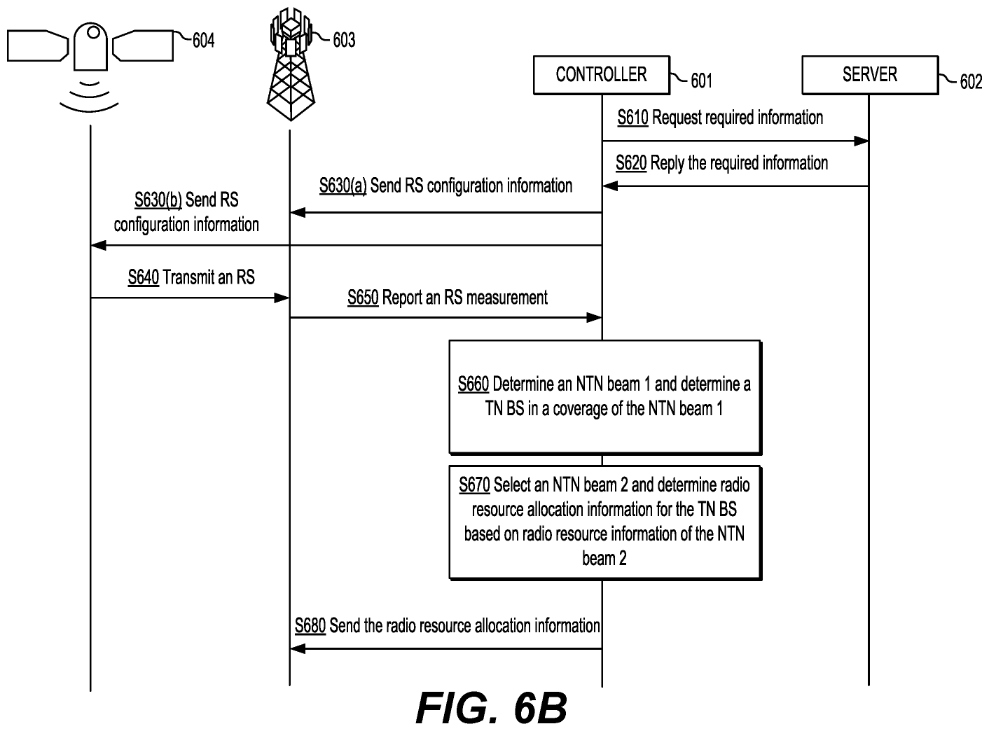

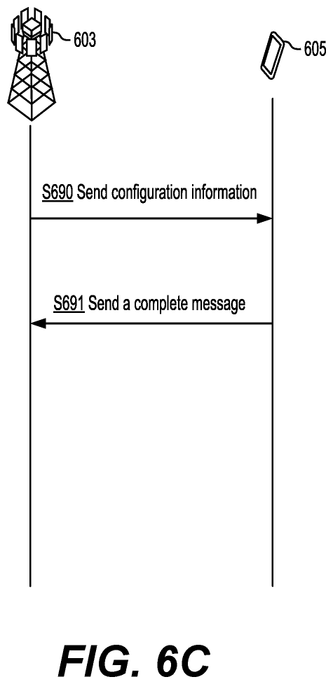

FIGS. 6A-6C shows exemplary signal flow diagrams of a TN-NTN system according to embodiments of the disclosure. The TN-NTN system can include a controller 601, a server 602, a TN BS 603, a satellite 604, and a TN UE 605.

Specifically, in FIG. 6A, at step S610, the controller 601 can send a request message to the server 602 to request information for allocating a radio resource to the TN BS 603. The information for allocating the radio resource can be referred to as required information. At step S620, the server 602 can send to the controller 601 a response message carrying the required information for allocating the radio resource. At step S660, the controller 601 can determine an NTN beam (e.g., NTN beam 1), and determine that the TN BS 603 is in a beam coverage of the NTN beam 1. At step S670, the controller 601 can select another NTN beam (e.g., NTN beam 2), and determine radio resource information for the TN BS 603 based on radio resource information of the NTN beam 2. The controller 601 can allocate a radio resource to the TN BS 603 based on a radio resource of the NTN beam 2. At step S680, the controller 601 can send the radio resource allocation information to the TN BS 603.

In an embodiment, the controller 601 and the server 602 can be collocated.

In an embodiment, the controller 601 can locate at a BS.

In an embodiment, the controller 601 can be at a gateway (GW).

In FIG. 6B, the controller 601 can determine the beam coverage of the NTN beam 1 based on a reference signal (RS) measurement. Specifically, at step S630(a) and step S630(b), the controller 601 can send RS configuration information to the TN BS 603 and the satellite 604, respectively. At step S640, the satellite 604 can transmit an RS based on the RS configuration. At step S650, the TN BS 603 can measure the RS based on the RS configuration and report the RS measurement to the controller 601. The steps S610, S620, S660, S670, and S680 are the same as those described in FIG. 6A and thus are not further described.

In FIG. 6C, at step S690, the TN BS 603 can send configuration information to the TN UE 605. The TN BS 603 can follow the RS configuration information and the radio resource allocation information received from the controller 601.

In an embodiment, the TN BS 603 can configure a cell and transmit a cell configuration message to the TN UE 605 according to the radio resource allocation information.

In an embodiment, the TN BS 603 can de-configure a cell and transmit a cell de-configuration message to the TN UE 605 according to the radio resource allocation information.

At step S691, the TN US 605 can access or leave a cell according to the received configuration information from the TN BS 603, and send a complete message to the TN BS 603 after receiving the cell configuration or de-configuration message.

The disclosure provides a method of radio resource allocation of a one or more TN cells. The method includes allocating a radio resource to each of the one or more TN cells based on a radio resource of a first NTN cell. The one or more TN cells are not in a coverage of the first NTN cell and are in a coverage of a second NTN cell. The first NTN cell and the second NTN cell are using different radio resource.

In an embodiment, the radio resource allocated to the one or more TN cells includes a first frequency range which is overlapped with a second frequency range used by the first NTN cell.

In an embodiment, the radio resource allocated to the one or more TN cells include a first time duration which is overlapped a second time with the first NTN cell.

In an embodiment, the radio resource allocated to the one or more TN cells includes a first polarization which is the same as a second polarization used by the first NTN cell.

In an embodiment, the coverage of the first NTN cell can be defined as a geographical area (i) with a distance from a reference point smaller than a distance threshold, (ii) with an NTN beam off-axis angle from a steering angle smaller than an angle threshold, and/or (iii) with a received NTN RSRP or RSRQ from the first NTN cell larger than a signal quality threshold.

In an embodiment, the first NTN cell and the second NTN cell are associated with the same satellite.

In an embodiment, the first NTN cell and the second NTN cell are associated with different satellites.

The disclosure provides a controller for radio resource allocation to one or more TN cells. The controller can send RS configuration information to a TN BS and a satellite. The controller can send a request message to a server to request information for the radio resource allocation. The controller can determine an NTN beam (e.g., beam 1), and determine one or more TN BSs which are in a beam coverage of the NTN beam 1. The controller can select another NTN beam (e.g., beam 2), and allocate a radio resource to the one or more TN BSs based on a radio resource of the NTN beam 2. The controller can send the radio resource allocation information to the one or more TN BSs.

In an embodiment, the controller can locate at a TN BS.

In an embodiment, the controller can be at a GW.

In an embodiment, the controller can be collocated with the server.

In an embodiment, the controller can determine the one or more TN BSs are in the coverage of the NTN beam 1 when the one or more TN BSs are located within a geographical area with a distance from a reference point, or when the one or more TN BSs are located within a geographical area with an NTN beam off-axis angle from a steering angle, or when the one or more TN BSs are located within a geographical area defined by a received NTN RSRP or RSRQ threshold from the first NTN cell.

In an embodiment, the radio resource allocation information can include sharing indication information and/or a RSRP (or RSRQ) threshold. The sharing indication information indicates a radio resource that can be shared by the one or more TN BSs.

In an embodiment, the controller can utilize a satellite to transmit a spectrum sharing messages to the one or more TN BSs. The spectrum sharing message can indicate a radio resource that can be shared by the one or more TN BSs.

In an embodiment, the required information can include a distance from a reference point, an NTN beam off-axis angle from a steering angle, a received NTN RSRP or RSRQ threshold from the first NTN cell, and/or coordinates of the one or more TN BSs.

In an embodiment, the satellite can follow the RS configuration information from the controller. The satellite can transmit a reference signal based on the RS configuration.

In an embodiment, the one or more TN BSs can follow the RS configuration information and the radio resource allocation information received from the controller. According to the radio resource allocation information, the one or more TN BSs can configure a TN cell and transmit a TN cell configuration message to a TN UE, or de-configure a TN cell and transmit a TN cell de-configuration message to the TN UE.

This disclosure provides a TN UE that can access or leave a TN cell according to a received TN cell configuration or de-configuration message from a TN BS. The TN UE can send a complete message to the TN BS after receiving the TN cell configuration or de-configuration message.

This disclosure provides a server for collecting TN information from one or more TN cells and NTN information from one or more NTN cells. The server can receive a request message from a controller. The request message requests information for radio resource allocation. The server can send a response message carrying the information for radio resource allocation. The information for radio resource allocation can include the TN information of the one or more TN cells and/or the NTN information of the one or more NTN cells.

Aspects of the disclosure provide a method of radio resource allocation for a TN cell. The method includes determining that the TN cell is outside a coverage of a first NTN cell. In response to the TN cell being outside the coverage of the first NTN cell, the method further includes allocating a radio resource to the TN cell based on a radio resource of the first NTN cell.

In an embodiment, a frequency range of the radio resource allocated to the TN cell overlaps with a frequency range of the radio resource of the first NTN cell.

In an embodiment, a time duration of the radio resource allocated to the TN cell overlaps with a time duration of the radio resource of the first NTN cell.

In an embodiment, a polarization of the radio resource allocated to the TN cell is the same as a polarization of the radio resource of the first NTN cell.

In an embodiment, the method includes determining that the TN cell is in a coverage of a second NTN cell based on at least one of a distance comparison, an angle comparison, or a signal quality comparison between the TN cell and the second NTN cell, and determining that the TN cell is outside the coverage of the first NTN cell based on a coverage comparison between the first and second NTN cells.

In an embodiment, the distance comparison includes comparing a distance threshold with a distance difference between a reference point of the second NTN cell and a base station of the TN cell.

In an embodiment, the angle comparison includes comparing an angle threshold with an angle difference between a first direction of a satellite to a reference point of the second NTN cell and a second direction of the satellite to a base station of the TN cell. The satellite is associated with the second NTN cell.

In an embodiment, the signal quality comparison includes comparing a signal quality threshold with a signal quality of a reference signal sent from the second NTN cell to a base station of the TN cell.

In an embodiment, the coverage comparison includes comparing a distance threshold with a distance difference between the first NTN cell and the second NTN cell.

In an embodiment, the coverage comparison includes determining whether the coverage of the first NTN cell overlaps with the coverage of the second NTN cell.

In an embodiment, the first NTN cell and the second NTN cell are associated with a same satellite.

In an embodiment, the first NTN cell and the second NTN cell are associated with different satellites.

In an embodiment, the radio resources of the first NTN cell and the second NTN cell are different.

In an embodiment, in response to the radio resource of the first NTN cell being used for uplink transmission, the method includes determining that the radio resource allocated to the TN cell is used for uplink transmission. In response to the radio resource of the first NTN cell being used for downlink transmission, the method includes determining that the radio resource allocated to the TN cell is used for downlink transmission.

In an embodiment, in response to the radio resource of the first NTN cell being used for uplink transmission, the method includes determining that the radio resource allocated to the TN cell is used for downlink transmission. In response to the radio resource of the first NTN cell being used for downlink transmission, the method includes determining that the radio resource allocated to the TN cell is used for uplink transmission.

In an embodiment, the method includes transmitting reference signal configuration information to at least one of a satellite associated with the second NTN cell or a base station of the TN cell.

In an embodiment, the method includes performing data transmission between a BS of the TN cell and a UE based on the radio resource allocated to the TN cell.

In an embodiment, the method includes transmitting a cell configuration message from the BS to the UE to inform the UE to access the TN cell.

In an embodiment, the method includes transmitting a cell de-configuration message from the BS to the UE to inform the UE to leave the TN cell.

Aspects of the disclosure provide an apparatus (e.g., apparatus 700) for radio resource allocation for a TN cell. Processing circuitry (e.g., processing circuitry 710) of the apparatus determines that the TN cell is outside a coverage of a first NTN cell. In response to the TN cell being outside the coverage of the first NTN cell, the processing circuitry of the apparatus allocates a radio resource to the TN cell based on a radio resource of the first NTN cell.

In an embodiment, a frequency range of the radio resource allocated to the TN cell overlaps with a frequency range of the radio resource of the first NTN cell.

In an embodiment, a time duration of the radio resource allocated to the TN cell overlaps with a time duration of the radio resource of the first NTN cell.

In an embodiment, a polarization of the radio resource allocated to the TN cell is the same as a polarization of the radio resource of the first NTN cell.

In an embodiment, the processing circuitry determines that the TN cell is in a coverage of a second NTN cell based on at least one of a distance comparison, an angle comparison, or a signal quality comparison between the TN cell and the second NTN cell, and determines that the TN cell is outside the coverage of the first NTN cell based on a coverage comparison between the first and second NTN cells.

In an embodiment, the distance comparison includes comparing a distance threshold with a distance difference between a reference point of the second NTN cell and a base station of the TN cell.

In an embodiment, the angle comparison includes comparing an angle threshold with an angle difference between a first direction of a satellite to a reference point of the second NTN cell and a second direction of the satellite to a base station of the TN cell. The satellite is associated with the second NTN cell.

In an embodiment, the signal quality comparison includes comparing a signal quality threshold with a signal quality of a reference signal sent from the second NTN cell to a base station of the TN cell.

In an embodiment, the coverage comparison includes comparing a distance threshold with a distance difference between the first NTN cell and the second NTN cell.

In an embodiment, the coverage comparison includes determining whether the coverage of the first NTN cell overlaps with the coverage of the second NTN cell.

In an embodiment, the first NTN cell and the second NTN cell are associated with a same satellite.

In an embodiment, the first NTN cell and the second NTN cell are associated with different satellites.

In an embodiment, the radio resources of the first NTN cell and the second NTN cell are different.

In an embodiment, in response to the radio resource of the first NTN cell being used for uplink transmission, the processing circuitry determines that the radio resource allocated to the TN cell is used for uplink transmission. In response to the radio resource of the first NTN cell being used for downlink transmission, the processing circuitry determines that the radio resource allocated to the TN cell is used for downlink transmission.

In an embodiment, in response to the radio resource of the first NTN cell being used for uplink transmission, the processing circuitry determines that the radio resource allocated to the TN cell is used for downlink transmission. In response to the radio resource of the first NTN cell being used for downlink transmission, the processing circuitry determines that the radio resource allocated to the TN cell is used for uplink transmission.

In an embodiment, the processing circuitry transmits reference signal configuration information to at least one of a satellite associated with the second NTN cell or a base station of the TN cell.

In an embodiment, the processing circuitry performs data transmission between a BS of the TN cell and a UE based on the radio resource allocated to the TN cell.

In an embodiment, the processing circuitry transmits a cell configuration message from the BS to the UE to inform the UE to access the TN cell.

In an embodiment, the processing circuitry transmits a cell de-configuration message from the BS to the UE to inform the UE to leave the TN cell.

### System Architecture

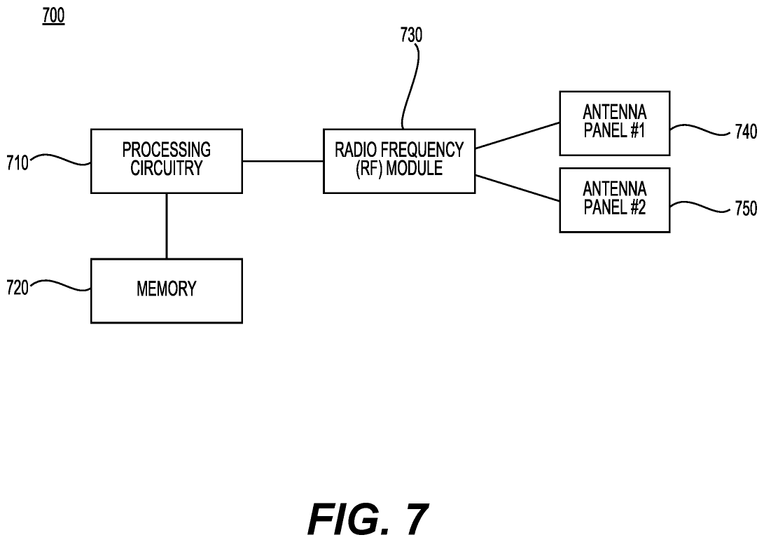

FIG. 7 shows an exemplary apparatus 700 according to embodiments of the disclosure. The apparatus 700 can be configured to perform various functions in accordance with one or more embodiments or examples described herein. Thus, the apparatus 700 can provide means for implementation of techniques, processes, functions, components, systems described herein. For example, the apparatus 700 can be used to implement functions of a UE or a base station (BS) (e.g., gNB) in various embodiments and examples described herein. The apparatus 700 can include a general-purpose processor or specially designed circuits to implement various functions, components, or processes described herein in various embodiments. The apparatus 700 can include processing circuitry 710, a memory 720, a radio frequency (RF) module 730, and two antenna panels 740 and 750.

In various examples, the processing circuitry 710 can include circuitry configured to perform the functions and processes described herein in combination with software or without software. In various examples, the processing circuitry 710 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 710 can be a central processing unit (CPU) configured to execute program instructions to perform various functions and processes described herein. Accordingly, the memory 720 can be configured to store program instructions. The processing circuitry 710, when executing the program instructions, can perform the functions and processes. The memory 720 can further store other programs or data, such as operating systems, application programs, and the like. The memory 720 can include a read only memory (ROM), a random-access memory (RAM), a flash memory, a solid state memory, a hard disk drive, an optical disk drive, and the like.

The RF module 730 receives a processed data signal from the processing circuitry 710 and converts the data signal to beamforming wireless signals that are then transmitted via the antenna panels 740 and/or 750, or vice versa. The RF module 730 can include a digital to analog convertor (DAC), an analog to digital converter (ADC), a frequency up convertor, a frequency down converter, filters and amplifiers for reception and transmission operations. The RF module 730 can include multi-antenna circuitry for beamforming operations. For example, the multi-antenna circuitry can include an uplink spatial filter circuit, and a downlink spatial filter circuit for shifting analog signal phases or scaling analog signal amplitudes. Each of the antenna panels 740 and 750 can include one or more antenna arrays.

In an embodiment, part of all the antenna panels 740/750 and part or all functions of the RF module 730 are implemented as one or more TRPs (transmission and reception points), and the remaining functions of the apparatus 700 are implemented as a BS. Accordingly, the TRPs can be co-located with such a BS, or can be deployed away from the BS.

The apparatus 700 can optionally include other components, such as input and output devices, additional or signal processing circuitry, and the like. Accordingly, the apparatus 700 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random-access memory (RAM), a read-only memory (ROM), a magnetic disk and an optical disk, and the like. The computer-readable non-transitory storage medium can include all types of computer readable medium, including magnetic storage medium, optical storage medium, flash medium, and solid-state storage medium.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of radio resource allocation for a terrestrial network (TN) cell, the method comprising:
determining that the TN cell is outside a coverage of a first non-terrestrial network (NTN) cell; and
in response to the TN cell being outside the coverage of the first NTN cell, allocating a radio resource to the TN cell based on a radio resource of the first NTN cell.

2. The method of claim 1, wherein a frequency range of the radio resource allocated to the TN cell overlaps with a frequency range of the radio resource of the first NTN cell.

3. The method of claim 1, wherein a time duration of the radio resource allocated to the TN cell overlaps with a time duration of the radio resource of the first NTN cell.

4. The method of claim 1, wherein a polarization of the radio resource allocated to the TN cell is the same as a polarization of the radio resource of the first NTN cell.

5. The method of claim 1, wherein the determining includes:
determining that the TN cell is in a coverage of a second NTN cell based on at least one of a distance comparison, an angle comparison, or a signal quality comparison of the TN cell and the second NTN cell; and
determining that the TN cell is outside the coverage of the first NTN cell based on a coverage comparison between the first and second NTN cells.

6. The method of claim 5, wherein the distance comparison includes comparing a distance threshold with a distance difference between a reference point of the second NTN cell and a base station of the TN cell.

7. The method of claim 5, wherein the angle comparison includes comparing an angle threshold with an angle difference between a first direction of a satellite to a reference point of the second NTN cell and a second direction of the satellite to a base station of the TN cell, the satellite being associated with the second NTN cell.

8. The method of claim 5, wherein the signal quality comparison includes comparing a signal quality threshold with a signal quality of a reference signal sent from the second NTN cell to a base station of the TN cell.

9. The method of claim 5, wherein the coverage comparison includes comparing a distance threshold with a distance difference between the first NTN cell and the second NTN cell.

10. The method of claim 5, wherein the coverage comparison includes determining whether the coverage of the first NTN cell overlaps with the coverage of the second NTN cell.

11. The method of claim 5, wherein the first NTN cell and the second NTN cell are associated with a same satellite.

12. The method of claim 5, wherein the first NTN cell and the second NTN cell are associated with different satellites.

13. The method of claim 5, wherein the radio resources of the first NTN cell and the second NTN cell are different.

14. The method of claim 1, wherein the allocating includes:
in response to the radio resource of the first NTN cell being used for uplink transmission, determining that the radio resource allocated to the TN cell is used for uplink transmission; and
in response to the radio resource of the first NTN cell being used for downlink transmission, determining that the radio resource allocated to the TN cell is used for downlink transmission.

15. The method of claim 1, wherein the allocating includes:
in response to the radio resource of the first NTN cell being used for uplink transmission, determining that the radio resource allocated to the TN cell is used for downlink transmission; and
in response to the radio resource of the first NTN cell being used for downlink transmission, determining that the radio resource allocated to the TN cell is used for uplink transmission.

16. The method of claim 1, further comprising:
transmitting reference signal configuration information to at least one of a satellite associated with the second NTN cell or a base station of the TN cell.

17. The method of claim 1, further comprising:
transmitting a cell configuration message from a base station of the TN cell to a user equipment to inform the user equipment to access the TN cell.

18. The method of claim 1, further comprising:
transmitting a cell de-configuration message from a base station of the TN cell to a user equipment to inform the user equipment to leave the TN cell.

19. An apparatus, comprising:
processing circuitry configured to
determine that a terrestrial network (TN) cell is outside a coverage of a first non-terrestrial network (NTN) cell, and
in response to the TN cell being outside the coverage of the first NTN cell, allocate a radio resource to the TN cell based on a radio resource of the first NTN cell.

20. A non-transitory computer-readable medium storing instructions which, when executed by a processor, cause the processor to perform a method comprising:
determining that a terrestrial network (TN) cell is outside a coverage of a first non-terrestrial network (NTN) cell; and
in response to the TN cell being outside the coverage of the first NTN cell, allocating a radio resource to the TN cell based on a radio resource of the first NTN cell.
